(19) United States
(12) Patent Application Publication
(10) Pub. No.: US 2019/0144647 A1
(43) Pub. Date: May 16, 2019

(54) RUBBER COMPOSITION FOR TIRES, AND PNEUMATIC TIRE USING THE SAME

(71) Applicant: Toyo Tire & Rubber Co., Ltd., Itami-shi (JP)

(72) Inventor: Souichiro Miura, Itami-shi (JP)

(73) Assignee: Toyo Tire & Rubber Co., Ltd., Itami-shi (JP)

(21) Appl. No.: 16/169,408

(22) Filed: Oct. 24, 2018

(30) Foreign Application Priority Data
Nov. 16, 2017 (JP) 2017-221193

(51) Int. Cl. C08L 9/06; B60C 1/00

(52) U.S. Cl. CPC C08L 9/06; B60C 1/0016; C08L 2207/04; C08L 2205/025; C08L 2205/03; B60C 1/0025

(57) ABSTRACT

A rubber composition for tires is disclosed, which is capable of improving fuel efficiency, wet grip performance, and low-temperature characteristics, and also a pneumatic tire using the same. A rubber composition for tires, including al rubber component, an inorganic filler, a thermoplastic elastomer containing a functional group that reacts or interacts with a surface functional group of the inorganic filler and having a specific gravity of 1.00 or less, and a phosphate having a coagulation point of −55° C. or less

### TECHNICAL FIELD

The present invention relates to a rubber composition for tires and also to a pneumatic tire using the same.

### BACKGROUND ART

Pneumatic tires are lectured to not only have excellent fuel efficiency but also be excellent in grip performance on a wet road, that is, wet grip performance. However, these characteristics contradict each other, and thus it is not easy to improve them at the same time. In addition, at low temperatures, the elastic modulus of a rubber composition increases, resulting in a decrease in grip performance. Therefore, in winter tires, there are also problems with low-temperature characteristics.

As a tire capable of reducing the rolling resistance, that is, capable of improving fuel efficiency, of a tire tread without impairing other properties, particularly wet grip characteristics, PTL 1 discloses a tire characterized in that the tread includes a rubber composition containing at least one kind of diene elastomer, at least one land of reinforcing filler, and more than 10 phr of a hydrogenated styrene thermoplastic (“TPS”) elastomer.

For the purpose of improving grip performance and wear resistance, PTL 2 discloses a rubber composition including a rubber component blended with a solid resin and a plasticizer such as a phosphate.

However, PTLs 1 and 2 are silent as to low-temperature characteristics and the specific gravity of a thermoplastic elastomer to be blended, and there still is room for further improvement in fuel efficiency, wet grip performance, and low temperature characteristics.

### CITATION LIST

### Patent Literature

[PTL 1] JP-T-2013-510939 (the term “JP-T” as used herein means a published Japanese translation of a PCT patent application)

[PTL 2] JP-A-2016-204503

[PTL 3] JP-A-2014-189698

[PTL 4] JP-A-2015-110703

[PTL 5] JP-A-2015-110704

### SUMMARY OF THE INVENTION

### Problems that the Invention is to Solve

In light the above points, an object of the invention is to provide a rubber composition for tires, which is capable of improving fuel efficiency, wet grip performance, and low-temperature characteristics, and also a pneumatic tire using the same.

Incidentally, in PTLs 3 to 5, for the purpose of improving grip performance, a rubber composition blended with a hydrogenated thermoplastic elastomer is disclosed. However, they are silent as to fuel efficiency and low-temperature characteristics.

### Means for Solving the Problems

In order to solve the above problems, the rubber composition for tires according to he invention includes a rubber component, an inorganic filler, a thermoplastic elastomer containing a functional group that reacts or interacts with a surface functional group of the inorganic filler and having a specific gravity of 1.00 or less, and a phosphate having a coagulation point of −55° C. or less.

It is possible that the thermoplastic elastomer is a block copolymer having polystyrene as a hard segment.

It is possible that the content of the phosphate is 1 to 30 parts by mass per 100 parts by mass of the rubber component.

It is possible that the functional group contained in the thermoplastic elastomer is at least one member selected from the group consisting of a hydroxyl group, an amino group, a carboxyl group, a silanol group, an alkoxysilyl group, an epoxy group, a glycidyl group, a polyether group, a polysiloxane group, and a maleic anhydride-derived functional group.

It is possible that the thermoplastic elastomer has a styrene content of 20 mass % or more.

It is possible that the thermoplastic elastomer is a block copolymer having at least one member selected from the group consisting of a hydrogenated butadiene/isopene copolymer, a hydrogenated polybutadiene, and a styrene/butadiene copolymer as a soft segment.

The pneumatic tire according to the invention is produced using the above rubber composition for tires.

### Advantage of the Invention

The rubber composition for tires of the invention makes it possible to obtain a pneumatic tire having improved fuel efficiency, wet grip performance, and low-temperature characteristics.

### Mode for Carrying out the Invention

Hereinafter, matters relevant to the practice of the invention will be described in detail.

A rubber composition for tires according to this embodiment includes a rubber component, an inorganic filler, a thermoplastic elastomer containing a functional group that reacts or interacts with a surface functional group of the inorganic filler and having a specific gravity of 1.00 or less, and a phosphate having a coagulation point of −55° C. or less.

The rubber component according to this embodiment is not particularly limited. Examples thereof include a natural rubber (NR), an isoprene rubber (IR), a butadiene rubber (BR), a styrene-butadiene rubber (SBR), a styrene-isoprene copolymer rubber, a butadiene-isoprene copolymer rubber, and a styrene-isoprene-butadiene copolymer rubber. These diene rubbers may be used alone, and it is also possible to use a blend of two or more kinds.

Specific examples of the diene rubbers listed above also include modified diene rubbers having, and thus modified with, at least one functional group selected from the group consisting of a hydroxyl group, an amino group, a carboxyl group, an alkoxy group, an alkoxysilyl group, and an epoxy group introduced into the molecular end or the molecular chain. Preferred modified diene rubbers are a modified SBR and/or a modified BR. In this embodiment, the diene rubber may be an unmodified diene rubber alone, a modified diene rubber alone, or a blend of a modified diene rubber and an unmodified diene rubber. In one embodiment, in 100 parts by mass of a diene rubber, 10 parts by mass or more of a modified SBR may be contained, or 10 to 80 parts by mass of a modified SBR and 90 to 20 parts by mass of an unmodified diene rubber (e.g., at least one member selected from SBR, BR, and NR) may be contained.

The thermoplastic elastomer according to this embodiment is not particularly limited as long as it contains a functional group that reacts or interacts with a surface functional group of the inorganic filler, and may be, for example, a thermoplastic elastomer whose functional group is at least one member selected from the group consisting of a hydroxyl group, an amino group, a carboxyl group, a silanol group, an alkoxysilyl group, an epoxy group, a glycidyl group, a polyether group, a polysiloxane group, and a maleic anhydride-derived functional group. As used therein, to “interact” means to electrically attract each other. In addition, “polyether group” refers to a group having two or more ether bonds, and “polysiloxane group” refers to a group having two or more siloxane bonds.

In addition, the specific gravity of the thermoplastic elastomer according to this embodiment is not particularly limited as long as it is 1.00 or less, but is preferably 0.80 to 0.95, and more preferably 0.85 to 0.95. Incidentally, as used therein, the specific gravity is a value calculated in accordance with ISO 1183.

As such thermoplastic elastomers, commercially available products may also be used. Specific examples thereof include “SEPTON HG-252” manufactured by Kuraray Co., Ltd, and “Tuftec MP10” and “Tuftec MI911” manufactured by Asahi Kasei Corporation. When a thermoplastic elastomer containing a functional group that reacts or interacts with a surface functional group of an inorganic filler is melt-kneaded with a rubber component a sea-island structure in which the rubber component serves as the continuous phase, while the thermoplastic elastomer serves as the dispersed phase, is obtained. The uniformly dispersed thermoplastic elastomer functions as if inorganic filler functions, whereby excellent wet grip performance is likely to be obtained. In addition, the inorganic filler reacts or interacts with the dispersed thermoplastic elastomer, whereby the dispersibility of the inorganic filler improves, and excellent fuel efficiency is likely to be obtained.

The thermoplastic elastomer is preferably a stryenic thermoplastic elastomer having polystyrene as a hard segment, and more preferably a styrenic thermoplastic elastomer further having at least one member selected from the group consisting of a hydrogenated butadiene/isoprene copolymer, a hydrogenated polybutadiene, and a styrene/butadiene copolymer as a soft segment. That is, it is more preferable that the thermoplastic elastomer is at least one member selected from the group consisting of a triblock copolymer consisting of polystyrene, hydrogenated butadiene/isoprene copolymer, and polystyrene (hereinafter sometimes referred to as SEEPS), a triblock copolymer consisting of polystyrene, hydrogenated polybutadiene, and polystyrene (hereinafter sometimes referred to as SEBS), and a triblock copolymer consisting of polystyrene, styrene/butadiene copolymer, and polystyrene (hereinafter sometimes referred to as S-SB-S).

In the case where the thermoplastic elastomer is a styrenic thermoplastic elastomer, its styrene content is not particularly limited, but is preferably 20 mass % or more, and more preferably 20 to 80 mass %. When the content is 20 mass % or more, excellent wet grip performance is likely to be obtained.

The content of the thermoplastic elastomer is not particularly limited, but is preferably 1 to 30 parts by mass, more preferably 1 to 20 parts by mass, and still more preferably 5 to 20 parts by mass per 100 parts by mass of the rubber component.

The phosphate according to this embodiment is not particularly limited as long as it has a coagulation point of −55° C. or less. For example, tris(2-ethylhexyl) phosphate (TOP), triethyl phosphate (TEP), and the like may be used. When a phosphate having a coagulation point of −55° C. or less is used, excellent fuel efficiency and low-temperature characteristics are likely to be obtained. Here, the coagulation point of a phosphate is a value measured using a differential scanning calorimeter (DSC-60A manufactured by Shimadzu Corporation). Specifically, a phosphate was hermetically sealed in an aluminum cell and inserted into a sample holder, then, while heating the sample holder from −100° C. to 25° C. at 20 K/min in a nitrogen atmosphere, the difference in the amount of heat from the standard substance was measured, and the temperature at which the endothermic peak was observed was defined as the coagulation point.

The content of the phosphate is 1 to 30 parts by mass, preferably 1 to 20 parts by mass, and more preferably 5 to 20 parts by mass per 100 parts by mass of the rubber component. When the content is 1 to 30 parts by mass, excellent fuel efficiency and low-temperature characteristics are likely to be obtained.

In the rubber composition according to this embodiment, as the inorganic filler, reinforcing fillers such as carbon black and silica may be used. That is, the inorganic filler may be carbon black alone, silica alone, or a combination of carbon black and silica. A combination of carbon black and silica is preferable. The content of the inorganic filler is not particularly limited, and is, for example, preferably 20 to 120 parts by mass, more preferably 20 to 100 parts by mass, and still more preferably 30 to 80 parts by mass per 100 parts by mass of the rubber component.

Carbon black is not particularly limited, and various known species may be used. The content of carbon black is preferably 1 to 70 parts by mass, more preferably 1 to 30 parts by mass, per 100 parts by mass of the rubber component.

Silica is not particularly limited either, but it is preferable to use wet silica, such as wet-precipitated silica or wet-gelled silica. In the case where silica is contained, in terms of the balance of tanδ of the rubber, the reinforcing properties, and the like, the content thereof is preferably 10 to 100 parts by mass, more preferably 15 to 70 parts by mass, per 100 parts by mass of the rubber component.

In the case where silica is contained, silane coupling agents, such as sulfide silane and mercapto silane, may further be contained. In the case where a silane coupling agent is contained, the content thereof is preferably 2 to 20 parts by mass per 100 parts by mass of silica.

In teams of improving wet grip performance, the rubber composition according to this embodiment may be further blended with resins. Examples of such resins include petroleum resins, rosin resins, and styrene resins. They may be used alone, and it is also possible to use a combination of two or more kinds. As these resins, those having a softening point of 80 to 140° C. are preferably used. Here, the softening point is a value measured in accordance with JIS K2207 (Ring-and-Ball Method).

Examples of petroleum resins include C5 aliphatic hydrocarbon resins, C9 aromatic hydrocarbon resins, and C5/C9 aliphatic/aromatic copolymerized hydrocarbon resins. An aliphatic hydrocarbon resin is a resin obtained by the cationic polymerization of an unsaturated monomer such as isoprene or cyclopentadiene, which is a petroleum fraction having to four to five carbon atoms (C5 fraction), and may also be hydrogenated. An aromatic hydrocarbon resin is a resin obtained by the cationic polymerization of a monomer such as vinyltoluene, an alkylstyrene, or indene, which is a petroleum fraction having to eight to ten carbon atoms (C9 fraction), and may also be hydrogenated. An aliphatic/aromatic copolymerized hydrocarbon resin is a resin obtained by the copolymerization of the above C5 fraction and C9 fraction by cationic polymerization, and may also be hydrogenated.

As rosin resins, various known ones may be used. Examples thereof include rosins such as raw material rosins including gum rosin, wood rosin, tall oil rosin, and the like, dispropoitionated products of raw material rosins, stabilized rosins obtained by the hydrogenation treatment of raw material rosins, and polymerized rosins, as well as esterified products of rosins (rosin ester resins), phenol-modified rosins, unsaturated acid-modified (e.g., maleic acid-modified) rosins, and formylated rosins obtained by the reduction treatment of rosins. Among them, polymerized rosins, phenol-modified rosins, unsaturated acid-modified rosins, and rosin ester resins are preferable, and unsaturated acid-modified rosins, such as rosin-modified maleic acid resins, are more preferable.

Examples of styrene resins include α-methylstyrene homopolymers, styrene/α-methylstyrene copolymers, styrene monomer/aliphatic monomer copolymers, α-methylstyrene/aliphatic monomer copolymers, and styrene monomer/α-methylstyrene/aliphatic monomer copolymers.

The resins listed above may be used alone, and it is also possible to use a combination of two or more kinds. The resin content is not particularly limited, but is preferably 1 to 30 parts by mass, more preferably 3 to 20 parts by mass, and still more preferably 5 to 15 parts by mass per 100 parts by mass of the rubber component. When the content is 1 to 30 parts by mass, excellent fuel efficiency is likely to be obtained.

In the rubber composition according to this embodiment, in addition to the components described above, formulated chemicals used in the usual rubber industry, such as process oils, zinc oxide, stearic acid, softeners, plasticizers, waxes, antioxidants, vulcanizers, and vulcanization accelerators, can be suitably blended within the usual range.

Examples of vulcanizers include sulfur components, such as powder sulfur, precipitated sulfur, colloidal sulfur, insoluble sulfur, and highly dispersed sulfur. The vulcanizer content is preferably 0.1 to 10 parts by mass, move preferably 0.5 to 5 parts by mass, per 100 parts by mass of the rubber component. In addition, the vulcanization accelerator content is preferably 0.1 to 7 parts by mass, more preferably 0.5 to 5 parts by mass, per 100 parts by mass of the rubber component.

The rubber composition according to this embodiment can be produced by kneading in the usual manner using a mixer that is usually used, such as a Banbury mixer, a kneader, or a roll. That is, in the first mixing stage, a thermoplastic elastomer, a phosphate, and also other additives excluding a vulcanizer and a vulcanization accelerator are added to a rubber component and mixed, and, in the final mixing stage, a vulcanizer and a vulcanization accelerator are added to the obtained mixture and mixed, whereby the rubber composition can be prepared.

The rubber composition obtained in this manner can be used for tires. The rubber composition is applicable to various parts of a tire, such as the tread part and the side wall part of pneumatic tires of various sizes for various applications, including automotive tires, large tires for trucks and bases, etc. A pneumatic tire can be produced by forming the rubber composition into a predetermined shape in the usual manner, such as by extrusion, and then combining with other parts, followed by vulcanization molding at 140 to 180° C., for example.

The kind of pneumatic tire according to this embodiment is not particularly limited. Examples thereof include, as described above, various tires such as automotive tires and heavy-load tires for trucks and buses.

### EXAMPLES

Hereinafter, examples of the invention will be shown, but the invention is not limited to these examples.

### Thermoplastic Elastomer Synthesis Example 1

In a pressure-resistant container equipped with a stirrer, 800 g of cyclohexane, 38 g of dehydrated styrene, and 7.7 g of a cyclohexane solution of sec-butyllithium (10 mass %) were added, and the polymerization reaction was carried out at 50° C. for 1 hour. 127 g of a mixture of styrene and butadiene (styrene:butadiene molar ratio=3:4) was added, and the polymerization reaction was carried out for 1 hour. Further, 38 g of styrene was added, and the polymerization reaction was carried out for 1 hour. Subsequently, 2.5 g of chlorotriethoxysilane was added, and finally methanol was added to stop the reaction. The reaction solution was distilled under reduced pressure to remove the solvent, thereby giving a thermoplastic elastomer 5, which is a styrene-(styrene/butadiene)-styrene block copolymer having an ethoxysilyl group at one end. The number average molecular weight of the obtained thermoplastic elastomer 5 was 163,000, and the styrene content was 74 mass %. Incidentally, the number average molecular weight and the styrene content were measured using GPC (gel permeation chromatography) “HPC-8020” manufactured by Tosoh Corporation. Tetrahydrofuran was used as the solvent, and the measurement was performed in terms of standard polystyrene.

### Thermoplastic Elastomer Synthesis Example 2

In a pressure-resistant container equipped with a stirrer, 800 g of cyclohexane, 38 g of dehydrated styrene, and 7.7 g of a cyclohexane solution of sec-butyllithium (10 mass %) were added, and the polymerization reaction was carried out at 50° C. for 1 hour. 127 g of a mixture of styrene and butadiene (styrene:butadiene molar ratio=3:4) was added, and the polymerization reaction was earned out for 1 hour. Further, 38 g of styrene was added and the polymerization reaction was carried out for 1 hour. Subsequently, 1.2 g of epichlorohydrin was added, and finally methanol was added to stop the reaction. The reaction solution was distilled under reduced pressure to remove the solvent, thereby giving a thermoplastic elastomer 6, which is a styrene-(styrene/butadiene)-styrene block copolymer having an epoxy group at one end. The number average molecular weight of the obtained thermoplastic elastomer 6 was 161,000, and the styrene content was 74 mass %. Incidentally, the number average molecular weight and the styrene content were measured in the same manner as in the above Synthesis Example 1.

### Examples and Comparative Examples

Using a Banbury mixer, following the formulation (part % mass) shown in Table 1 below, first, in the first mixing stage (non-processing kneading step), components excluding a vulcanization accelerator and sulfur were added and mixed (discharge temperature=160° C.) and, in the final mixing stage (processing kneading step), a vulcanization accelerator and sulfur were added to the obtained mixture and mixed (discharge temperature=90° C.), thereby preparing a rubber composition.

The details of the components in Table 1 are as follows.

SBR 1: “VSL5025-0HM” manufactured by LANXESS

SBR 2: Amino- and alkoxy-terminated modified solution-polymerized styrene-butadiene rubber, “HPR350” manufactured by JSR Corporation

BR: “BR150B” manufactured by Ube Industries, Ltd.

Thermoplastic Elastomer 1: “SEPTON 8006” manufactured by Kuraray Co., Ltd, terminally unmodified SEBS copolymer, styrene content: 33 mass %, specific gravity: 0.92

Thermoplastic Elastomer 2: “SEPTON HG-252” manufactured by Kuraray Co., Ltd., hydroxyl-terminated modified SEEPS copolymer, styrene content; 28 mass %, specific gravity: 0.90

Thermoplastic Elastomer 3: “Tuftec MP10” manufactured by Asahi Kasei Corporation, amino-terminated modified SEBS copolymer, styrene content 30 mass %, specific gravity: 0:91

Thermoplastic Elastomer 4; “Tuftec M1911” manufactured by Asahi Kasei Corporation, maleic anhydride-modified SEBS copolymer, styrene content 30 mass %, specific gravity: 0.91

Thermoplastic Elastomer 5: Thermoplastic elastomer obtained in Synthesis Example 1 above, alkoxysilyl-terminated modified S-SB-S copolymer, styrene content 74 mass %, specific gravity: 0.92

Thermoplastic Elastomer 6: Thermoplastic elastomer obtained in Synthesis Example 2 above, epoxy-terminated modified S-SB-S copolymer, styrene content: 74 mass %, specific gravity: 0.91

Thermoplastic Elastomer 7: “UH2170” manufactured by Toagosei Co., Ltd., hydroxyl group-containing styrene acrylic resin, specific gravity: 1.15

Thermoplastic Elastomer 8: “UC3900” manufactured by Toagosei Co., Ltd., carboxyl group-containing styrene acrylic resin, specific gravity: 1.19

Phosphate 1: Tris(2-ethylhexyl) phosphate (TOP) manufactured by Daihachi Chemical Industry Co., Ltd., coagulation point: −70° C. or less

Phosphate 2: Triethyl phosphate (TEP) manufactured by Daihachi Chemical Industry Co., Ltd., coagulation point: −56° C.

Phosphate 3: Trixylenyl phosphate (TXP) manufactured by Daihachi Chemical Industry Co., Ltd., coagulation point: −15° C.

Silica: “Nipsil AQ” manufactured by Tosoh Silica Corporation

Carbon black: “N339 SEAST KH” manufactured by Tokai Carbon Co., Ltd

Silane coupling agent: “Si69” manufactured by Evonik

Oil: “Process NC140” manufactured by JX Energy

Zinc oxide: “Zinc Oxide No. 1” manufactured by Mitsui Mining & Smelting Co., Ltd.

Antioxidant: “Antigen 6C” manufactured by Sumitomo Chemical Co., Ltd

Stearic acid: “LUNAC S-20” manufactured by Kao Corporation

Wax: “OZOACE0355” manufactured by Nippon Seiro Co., Ltd

Sulfur: “5% OIL TREATED SULFUR PONDER” manufactured by Tsurumi Chemical Industry Co., Ltd.

Vulcanization Accelerator 1: “SOXINOL CZ” manufactured by Sumitomo Chemical Co., Ltd.

Vulcanization Accelerator 2: “Nocceler D” manufactured by Ouchi Shinko Chemical Industrial Co., Ltd.

The coagulation point of each phosphate described above was measured as follows. Using a differential scanning calorimeter (DSC-60A manufactured by Shimadzu Corporation), a phosphate was hermetically sealed in an aluminum cell and inserted into a sample holder, and then, while heating the sample holder from −100° C. to 25° C. at 20 K/min in a nitrogen atmosphere, the difference in the amount of heat from the standard substance was measured. The coagulation point is the temperature at which the endothermic peak was thus observed.

The specific gravity of each thermoplastic elastomer described above is a value calculated in accordance with ISO 1183.

The wet grip performance, fuel efficiency, and low-temperature characteristics of each obtained rubber composition were evaluated. The evaluation methods are as follows.

Wet Grip Performance: Using a specimen of a predetermined shape prepared by vulcanizing the obtained rubber composition at 160° C. for 30 minutes, the loss factor tanδ was measured as the value using a viscoelasticity tester manufactured by Toyo Seiki Co., Ltd., in accordance with JIS K6394. The measurement conditions were as follows: frequency: 10 Hz, static strain: 10%, dynamic strain: 1%, temperature: 0° C. The result was expressed as an index taking the value of Comparative Example 1 as 100. A larger index indicates better wet grip performance.

Fuel Efficiency: Using a specimen of a predetermined shape prepared by vulcanizing the obtained rubber composition at 160° C. for 30 minutes, the loss factor tanδ was measured as the value using a viscoelasticity tester manufactured by Toyo Seiki Co., Ltd., in accordance with JIS K6394. The measurement conditions were as follows: frequency: 10 Hz, static strain: 10%, dynamic strain: 1%, temperature: 60° C. The result was expressed as an index taking the value of Comparative Example 1 as 100. A smaller index indicates better fuel efficiency.

Low-temperature characteristics: Using a specimen of a predetermined shape prepared by vulcanizing the obtained rubber composition at 160° C. for 30 minutes, the loss factor tanδ was measured as the value using a viscoelasticity tester manufactured by Toyo Seiki Co., Ltd., in accordance wife JIS K6394. The measurement conditions were as follows: frequency: 10 Hz, static strain: 10%, dynamic strain: 1%, temperature: −15° C. The result was expressed as an index taking the value of Comparative Example 1 as 100. A smaller index indicates better low-temperature characteristics.

TABLE 1

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| SBR1 | 70 | 70 | 70 | 70 | 70 | 70 |
| SBR2 | — | — | — | — | — | — |
| BR | 30 | 30 | 30 | 30 | 30 | 30 |
| Thermoplastic Elastomer 1 | — | — | — | 10 | — | — |
| Thermoplastic Elastomer 2 | — | — | — | — | — | — |
| Thermoplastic Elastomer 2 | — | — | 10 | — | — | — |
| Thermoplastic Elastomer 3 | — | — | — | — | — | — |
| Thermoplastic Elastomer 4 | — | — | — | — | — | — |
| Thermoplastic Elastomer 5 | — | — | — | — | — | — |
| Thermoplastic Elastomer 6 | — | — | — | — | — | — |
| Thermoplastic Elastomer 7 | — | — | — | — | 10 | — |
| Thermoplastic Elastomer 8 | — | — | — | — | — | 10 |
| Phosphate 1 | — | 10 | — | — | — | — |
| Phosphate 2 | — | — | — | — | — | — |
| Phosphate 3 | — | — | 10 | — | — | — |
| Silica | 70 | 70 | 70 | 70 | 70 | 70 |
| Carbon black | 10 | 10 | 10 | 10 | 10 | 10 |
| Siliane coupling agent | 7 | 7 | 7 | 7 | 7 | 7 |
| Oil | 20 | 10 | 20 | 20 | 20 | 10 |
| Zinc oxide | 3.0 | 3.0 | 3.0 | 3.0 | 3.0 | 3.0 |
| Antioxidant | 2.0 | 2.0 | 2.0 | 2.0 | 2.0 | 2.0 |
| Stearic acid | 2.0 | 2.0 | 2.0 | 2.0 | 2.0 | 2.0 |
| Wax | 2.0 | 2.0 | 2.0 | 2.0 | 2.0 | 2.0 |
| Sulfur | 1.5 | 1.5 | 1.5 | 1.5 | 1.5 | 1.5 |
| Vulcanization Accelerator 1 | 1.8 | 1.8 | 1.8 | 1.8 | 1.8 | 1.8 |
| Vulcanization Accelerator 2 | 2.0 | 2.0 | 2.0 | 2.0 | 2.0 | 2.0 |
| Wet grip performance | 100 | 96 | 110 | 112 | 103 | 102 |
| Fuel efficiency | 100 | 84 | 100 | 102 | 100 | 101 |
| Low-temperature | 100 | 88 | 102 | 106 | 98 | 99 |
| characteristics | | | | | | |

| | Example 1 | Example 2 | Example 3 | Example 4 | Example 5 | Example 6 | Example 7 | Example 8 | Example 9 | Example 10 |
|---|---|---|---|---|---|---|---|---|---|---|
| SBR1 | 70 | 70 | 70 | 70 | 70 | 70 | 70 | 70 | 70 | — |
| SBR2 | — | — | — | — | — | — | — | — | — | 70 |
| BR | 30 | 30 | 30 | 30 | 30 | 30 | 30 | 30 | 30 | 30 |
| Thermoplastic Elastomer 1 | — | — | — | — | — | — | — | — | — | — |
| Thermoplastic Elastomer 2 | — | — | — | — | — | — | — | — | — | — |
| Themloplastic Elastomer 2 | 10 | 20 | — | — | — | — | 10 | 10 | 10 | 10 |
| Thermoplastic Elastomer 3 | — | — | 10 | — | — | — | — | — | — | — |
| Thermoplastic Elastomer 4 | — | — | — | 10 | — | — | — | — | — | — |
| Thermoplastic Elastomer 5 | — | — | — | — | 10 | — | — | — | — | — |
| Thermoplastic Elastomer 6 | — | — | — | — | — | 10 | — | — | — | — |
| Thermoplastic Elastomer 7 | — | — | — | — | — | — | — | — | — | — |
| Thermoplastic Elastomer 8 | — | — | — | — | — | — | — | — | — | — |
| Phosphate 1 | 10 | 10 | 10 | 10 | 10 | 10 | — | — | — | 10 |
| Phosphate 2 | — | — | — | — | — | — | 5 | 10 | 20 | — |
| Phosphate 3 | — | — | — | — | — | — | — | — | — | — |
| Silica | 70 | 70 | 70 | 70 | 70 | 70 | 70 | 70 | 70 | 70 |
| Carbon black | 10 | 10 | 10 | 10 | 10 | 10 | 10 | 10 | 10 | 10 |
| Silane coupling agent | 7 | 7 | 7 | 7 | 7 | 7 | 7 | 7 | 7 | 7 |
| Oil | 20 | 20 | 20 | 20 | 20 | 20 | 20 | 20 | 20 | 10 |
| Zinc oxide | 3.0 | 3.0 | 3.0 | 3.0 | 3.0 | 3.0 | 3.0 | 3.0 | 3.0 | 3.0 |
| Antioxidant | 2.0 | 2.0 | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 | 2.0 | 2.0 |
| Wax | 2.0 | 2.0 | 2.0 | 2.0 | 2.0 | 2.0 | 2.0 | 2.0 | 2.0 | 2.0 |
| Sulfur | 1.5 | 1.5 | 1.5 | 1.5 | 1.5 | 1.5 | 1.5 | 1.5 | 1.5 | 1.5 |
| Vulcanization Accelerator 1 | 1.8 | 1.8 | 1.8 | 1.8 | 1.8 | 1.8 | 1.8 | 1.8 | 1.8 | 1.8 |
| Vulcanization Accelerator 2 | 2.0 | 2.0 | 2.0 | 2.0 | 2.0 | 2.0 | 2.0 | 2.0 | 2.0 | 2.0 |
| Wet grip performance | 110 | 116 | 110 | 112 | 118 | 116 | 104 | 116 | 106 | 103 |
| Fuel efficiency | 92 | 88 | 90 | 94 | 90 | 93 | 70 | 80 | 70 | 68 |
| Low-temperature | 92 | 88 | 90 | 94 | 90 | 93 | 70 | 80 | 70 | 68 |
| characteristics | | | | | | | | | | |

The results are as shown in Table 1. A comparison between Comparative Examples 1 to 6 and Examples 1 to 10 shows that when a predetermined thermoplastic elastomer and a predetermined phosphate are used together, the wet grip performance, fuel efficiency, and low-temperature characteristics are improved in a well-balanced manner.

### INDUSTRIAL APPLICABILITY

The rubber composition for tires of the invention can be used for various tires for automobiles, light trucks, buses, and the like.

1. A rubber composition for tires, comprising:
a rubber component;
an inorganic filler;
a thermoplastic elastomer containing a functional group that reacts or interacts with a surface functional group of the inorganic filler and having a specific gravity of 1.00 or less; and
a phosphate having a coagulation point of −55° C. or less.

2. The rubber composition for tires according to claim 1, wherein the content of the phosphate is 1 to 30 parts by mass per 100 parts by mass of the rubber component.

3. The rubber composition for tires according to claim 1, wherein the thermoplastic elastomer is a block copolymer having polystyrene as a hard segment.

4. The rubber composition for tires according to claim 2, wherein the thermoplastic elastomer is a block copolymer having polystyrene as a hard segment.

5. The rubber composition for tires according to claim 1, wherein the functional group contained in the thermoplastic elastomer is at least one member selected from the group consisting of a hydroxyl group, an amino group, a carboxyl group, a silanol group, an alkoxysilyl group, an epoxy group, a glycidyl group, a polyether group, a polysiloxane group, and a maleic anhydride-derived functional group.

6. The rubber composition for tires according to claim 2, wherein the functional group contained in the thermoplastic elastomer is at least one member selected from the group consisting of a hydroxyl group, an amino group, a carboxyl group, a silanol group, an alkoxysilyl group, an epoxy group, a glycidyl group, a polyether group, a polysiloxane group, and a maleic anhydride-derived functional group.

7. The rubber composition for tires according to claim 3, wherein the functional group contained in the thermoplastic elastomer is at least one member selected from the group consisting of a hydroxyl group, an amino group, a carboxyl group, a silanol group, an alkoxysilyl group, an epoxy group, a glycidyl group, a polyether group, a polysiloxane group, and a maleic anhydride-derived functional group.

8. The rubber composition for tires according to claim 4 wherein the functional group contained in the thermoplastic elastomer is at least one member selected from the group consisting of a hydroxyl group, an amino group, a carboxyl group, a silanol group, an alkoxysilyl group, an epoxy group, a glycidyl group, a polyether group, a polysiloxane group, and a maleic anhydride-derived functional group.

9. The rubber composition for fires according to claim 3, wherein the thermoplastic elastomer has a styrene content of 20 mass % or more.

10. The rubber composition for tires according to claim 5, wherein the thermoplastic elastomer has a styrene content of 20 mass % or more.

11. The rubber composition for tires according to claim 1, wherein the thermoplastic elastomer is a block copolymer having at least one member selected from the group consisting of a hydrogenated butadiene/isoprene copolymer, a hydrogenated polybutadiene, and a styrene/butadiene copolymer as a soft segment.

12. The rubber composition for tires according to claim 2, wherein the thermoplastic elastomer is a block copolymer having at least one member selected from the group consisting of a hydrogenated butadiene/isoprene copolymer, a hydrogenated polybutadiene, and a styrene/butadiene copolymer as a soft segment.

13. The rubber composition for tires according to claim 3, wherein the thermoplastic elastomer is a block copolymer having at least one member selected from the group consisting of a hydrogenated butadiene/isoprene copolymer, a hydrogenated polybutadiene, and a styrene/butadiene copolymer as a soft segment.

14. The rubber composition for tires according to claim 5, wherein the thermoplastic elastomer is a block copolymer haying at least one member selected from the group consisting of a hydrogenated butadiene/isoprene copolymer, a hydrogenated polybutadiene, and a styrene/butadiene copolymer as a soft segment.

15. A pneumatic tire produced using the rubber composition for tires according to claim 1.

16. A pneumatic tire produced using the rubber composition for tires according to claim 2.

17. A pneumatic tire produced using the rubber composition for tires according to claim 3.

18. A pneumatic tire produced using the rubber composition for tires according to claim 5.

19. A pneumatic the produced using the rubber composition for tires according to claim 11.
